(19) United States
(12) Patent Application Publication
(10) Pub. No.: US 2005/0024493 A1
(43) Pub. Date: Feb. 3, 2005

(54) Surveillance device

(76) Inventor: Ki Y. Nam, Newport Beach, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/844,206

(22) Filed: May 12, 2004

Related U.S. Application Data
(60) Provisional application No. 60/470,676, filed on May 15, 2003.

(51) Int. Cl. H04N 7/18

(52) U.S. Cl. 348/143

(57) ABSTRACT

A surveillance device that may be propelled, such as by throwing, into a room or other area for surveillance purposes. The device has an enclosure containing a solid state camera, a wireless transmitter, and a battery. The device is configured to seek a predetermined at rest position, and includes an omnidirectional imaging system positioned relative to the camera to provide a panoramic view of the immediate area to the camera for transmission when in the predetermined at rest position. Various embodiments are disclosed, including embodiments of different shapes, embodiments using one-way and two-way communication, embodiments using visible imaging and infrared imaging, embodiments including one or more microphones and/or other sensors and embodiments including direction sensing and communication capabilities.

### CROSS-REFERENCE TO RELATED APPLICATION

This application claims the benefit of U.S. Provisional Patent Application No. 60/470,676 filed May 15, 2003.

### BACKGROUND OF THE INVENTION

1. Field of the Invention

The present invention relates to the field of surveillance devices.

2. Prior Art

There are various situations where it would be desirable to know what it is in a room, whether it is occupied, what doors the room may have, etc., before entry into the room. By way of example, in the case of law enforcement, advance information regarding whether one or more suspects are in a room, whether children are present, what weapons might be visible, etc., would be highly desirable before officers make a forced entry. The present invention is intended for just such purpose, though may be used in other situations, as will become apparent.

### BRIEF DESCRIPTION OF THE DRAWINGS

FIG. 1 is a schematic illustration of one embodiment of the present invention.

FIG. 2 is a schematic illustration of another embodiment of the present invention.

FIG. 3 is a schematic illustration of still another embodiment of the present invention.

FIG. 4 is a schematic illustration of a still further embodiment of the present invention.

FIG. 5 is a schematic illustration of a one-way wireless link using a device in accordance with the present invention having a transmitter.

FIG. 6 is a schematic illustration of a two-way wireless link using a device in accordance with the present invention having a transceiver.

### DETAILED DESCRIPTION OF THE PREFERRED EMBODIMENTS

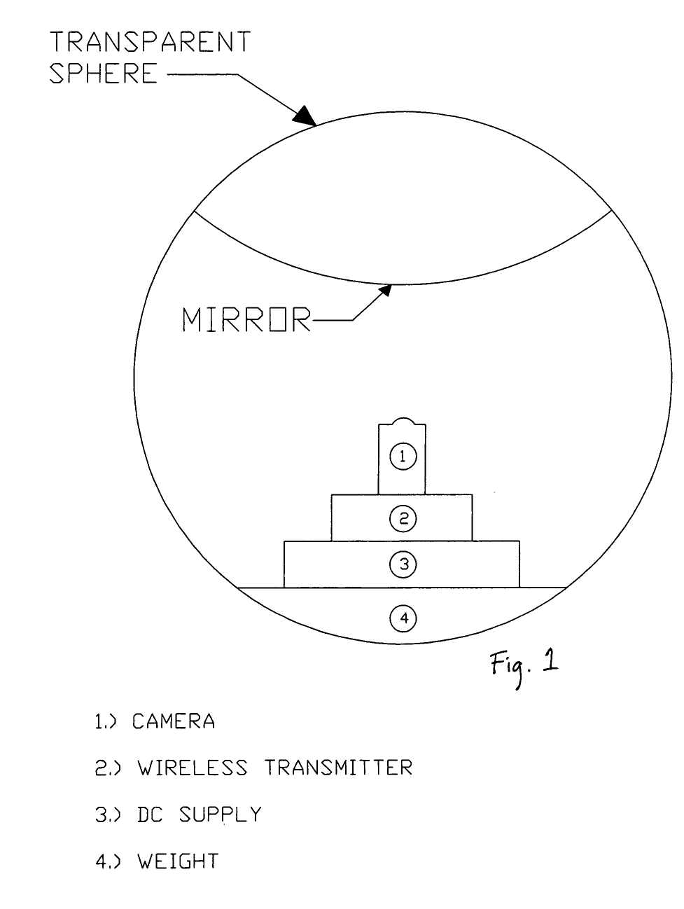

FIG. 1 is an illustration of one exemplary embodiment of the invention. This embodiment is of the nature of a transparent ball, or at least a ball-like structure transparent in the required regions. The device includes a camera 1, a wireless transmitter 2, a DC power supply (batteries) 3, and a weight 4. Of course, the batteries themselves may suffice as a weight, the purpose of the weight being to cause the ball-like structure to seek a preferred position, with the axis of the camera 1 being vertical and a mirror, shown schematically in FIG. 1, reflecting a 360° image of the room to the camera.

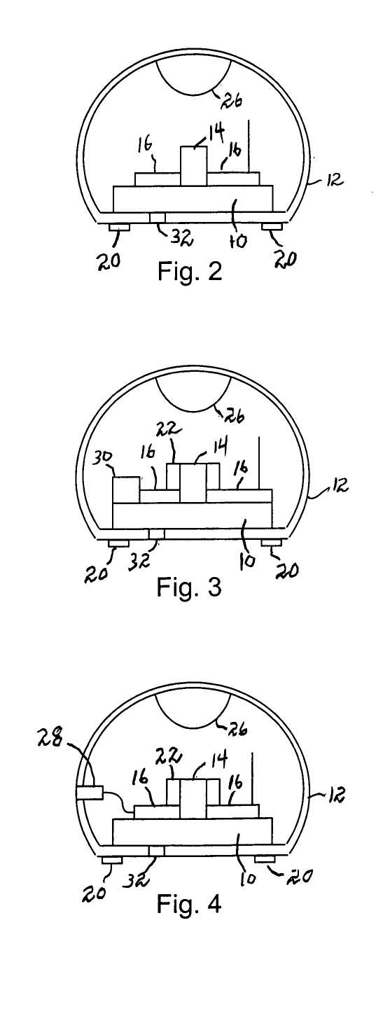

Embodiments using the batteries as a weight are shown in FIGS. 2, 3 and 4. In these embodiments, batteries 10 cover the inside base of the enclosure 12, with the camera 14 surrounded by the electronics 16 for the camera and radio being mounted above the batteries.

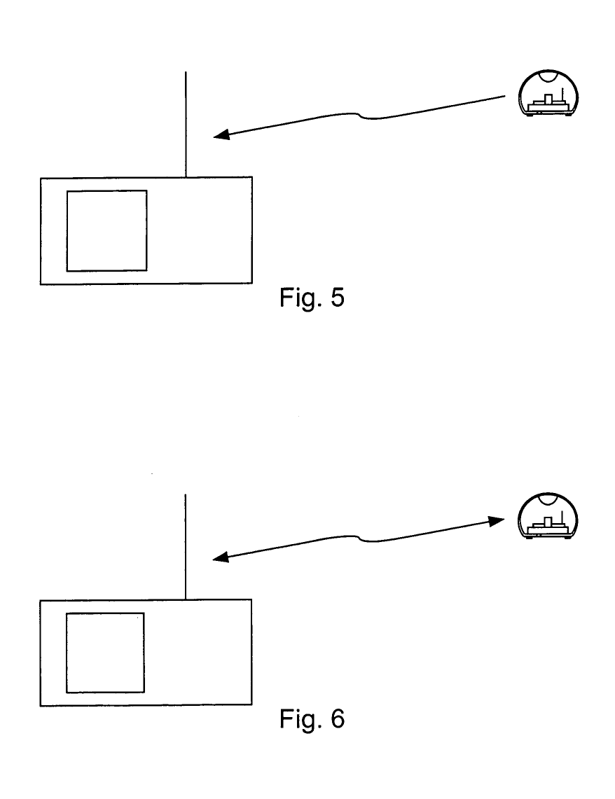

In use, one or more devices of the present invention may be thrown through a window or otherwise injected into, or possibly just left in a room, with the wireless transmitter transmitting either still pictures or video, such as by way of example, slow frame video, to a receiver a safe distance away (see FIG. 5). Given the intended use, the enclosure 12 may be manufactured from a high impact resistance, clear plastic such as clear polycarbonate. Other forms of propelling may also be used, such as a compressed gas, sling shot and the like, though there is a survival limit as to the energy that may imparted to the device, as the device is intended to function when it is in a settled position, not while it is airborne.

The device of the present invention may be made of any size, though can be quite small, such as golf ball size or even smaller, as solid state camera sensors are very small, as are RF transmitters, and transmitting range may be quite limited to still achieve the desired result. Also if desired, the device of the present invention may be of some shape other than purely spherical, such as by way of example, flattened on the bottom for quicker settling to an erect position. By way of example, the embodiments of FIGS. 2, 3 and 4 are of such a configuration, with an energy absorbing ring or feet 20 around the flattened area such as a foam or soft rubber to encourage the device to quickly settle if thrown into an uncarpeted room, such a room having a concrete, hardwood or tile floor.

Other embellishments may include the inclusion of lighting 22 (FIGS. 3 and 4), such as by way of super bright LEDs positioned around the camera 14 to illuminate the room using the same mirror 26 as is used to reflect the image of the room back to the camera 14. Such LEDs or other light sources might be pulsed or steadily on, as desired. In that regard, while the mirror 26 schematically shown in the Figures is suggested as being convex, the mirror may be a somewhat conical mirror with the point of the cone pointing downward toward the axis of the camera, with the surface of the cone-like mirror having a surface shaped to reflect the room image to the sensor. The specific design of the mirror is a matter of design choice, though is well within the skill of one skilled in the art. In that regard, various systems for providing a panoramic image to a camera are well known in the prior art, and need not be shown herein in detail. See for instance, U.S. Pat. No. 5,760,826 which provides details relating to a conventional omnidirectional visual sensor utilizing a paraboloidal mirror. Also, in place of or in addition to one or more mirrors, lenses of appropriate configuration may also be used. For examples of various omnidirectional vision systems, see U.S. Pat. Nos. 5,920,376, 6,130,783, 6,157,018, 6,704,148, 6,304,285 and 6,375,366.

Similarly, the field of view may be selected as desired, perhaps ranging from somewhat downward to upward at a significant angle, recognizing that the device will most likely be located at floor level. Still other features could be incorporated, if desired. By way of example, a sensor 28 (FIG. 4) such as a microphone may be included to pick up voice and other sounds, whether the person speaking is within view of the camera or not. Also, a magnetometer or some other magnetic field sensing device 30 could be included to provide some orientation for the image obtained. Other sensors 28 could be incorporated for other purposes, such as toxic gas sensors, explosive gas sensors, etc. In some cases, the enclosure may be vented with the sensor mounted within the enclosure for protection during dispatch of the device to the surveillance area. If desired, multiple sensors of the same or different characteristics may be distributed around the periphery of the device. If multiple microphones are used, the microphone with the strongest signal may be used, or the microphone signals may be multiplexed, or if the transmitter is a transceiver (see FIG. 6), the best microphone to use might be remotely selected by sampling all microphone signals.

For the lighting 22, infrared LEDs or other infrared lighting might be provided in place of super bright LEDs or other visible light lighting, with the camera 14 being infrared sensitive to provide surveillance, typically though not necessarily short-term surveillance, in darkness without ease of detection. Preferably the infrared light source would be pulsed each time an image is to be taken to maximize battery life. Further, without infrared lighting, the foregoing device could be highly useful by firefighters, the infrared sensitive camera 14 providing an infrared image of a room within a burning building prior to contemplated entry by firefighting personnel.

It is contemplated that the wireless transmitter within the present invention be a one-way communication system, with the device of the present invention being either preprogrammed or possibly programmed through one or more switches 32 at the time of initiation to set frame rate, etc. Alternatively, the wireless transmitter could be a transceiver for changing frame rate or other functions of the device under remote control when conditions change, such as when a suspect enters the room. Of course, the transmitter will preferably be configured to transmit only as required to conserve battery power. For this purpose, the device may be programmed to not transmit unless of until a noise is picked up, such as would be caused by one entering the room.

The foregoing has described certain preferred embodiments and various alternative embodiments and features of the invention by way of example, and not by way of limitation. Thus, it will be obvious to those skilled in the art that various additional changes may be made and additional features incorporated, all within the spirit and scope of the invention.

1. A surveillance device comprising:
an enclosure configured and weighted to tend to settle in a predetermined orientation when propelled into a room;
a battery in the enclosure;
a camera located in the enclosure and coupled to the battery;
an imaging system located in the enclosure relative to the camera for presenting a panoramic image of a room to the camera when the enclosure is in the predetermined orientation in a room;
a transmitter in the enclosure coupled to the camera and the battery to broadcast images presented to the camera by the imaging system.

2. The device of claim 1 wherein the images are still images.

3. The device of claim 1 wherein the images are video images.

4. The device of claim 3 wherein the images are slow frame video images.

5. The device of claim 1 wherein the camera is an infrared camera and the images are infrared images.

6. The device of claim 5 further comprised of an infrared light source positioned to illuminate the panoramic view.

7. The device of claim 6 further comprised of a control to pulse the infrared light source each time an image is to be taken by the camera.

8. The device of claim 1 further comprising manual camera and transmitter controls.

9. The device of claim 1 wherein the transmitter is a transceiver.

10. The device of claim 9 further comprising camera and transmitter controls responsive to wireless commands received by the transceiver.

11. The device of claim 1 wherein the camera is a visible light camera and the images are visible images.

12. The device of claim 11 further comprising a visible light source positioned to illuminate the panoramic view.

13. The device of claim 12 further comprised of a control to pulse the visible light source each time an image is to be taken by the camera.

14. The device of claim 1 further comprised of at least one additional sensor within the enclosure and having its output coupled to the transmitter.

15. The device of claim 14 wherein the additional sensor is a microphone.

16. The device of claim 14 wherein the additional sensor is a noxious gas sensor.

17. The device of claim 14 wherein the additional sensor is an explosive gas sensor.

18. The device of claim 1 wherein the enclosure is substantially spherical and is configured and weighted to tend to settle in a predetermined orientation when propelled into a room, at least in part, by off-center placement of the battery within the enclosure.

19. The device of claim 1 wherein the enclosure has one approximately flat surface, the battery being mounted adjacent the flat surface.

20. The device of claim 1 further comprising an earth's magnetic field sensor coupled to the transmitter to transmit directional information.

21. The device of claim 1 wherein the device has a size facilitating the throwing of the device by a user.

22. A method of surveillance comprising:
providing a surveillance device having;
an enclosure configured and weighted to tend to settle in a predetermined orientation when propelled into a room, the enclosure having within the enclosure;
a battery;
a camera coupled to the battery;
an imaging system located relative to the camera for presenting a panoramic image of a room to the camera when the enclosure is in the predetermined orientation in a room; and
a transmitter coupled to the camera and the battery to broadcast images presented to the camera by the imaging system;
activating the transmitter;
propelling the surveillance device into an area to be monitored; and
receiving images transmitted by the transmitter.

23. The method of claim 22 wherein the received images are still images after the device settles to a stable position.

24. The method of claim 22 wherein the received images are video images.

25. The method of claim 24 wherein the received images are slow frame video images.

26. The method of claim 22 wherein the received images are infrared images.

27. The method of claim 22 wherein an infrared light source within the enclosure source positioned to illuminate the panoramic view is pulsed each time the camera obtains an infrared image for transmitting.

28. The method of claim 22 wherein the transmitter is a transceiver.

29. The method of claim 28 wherein the camera and transmitter are responsive to wireless commands received by the transceiver.

30. The method of claim 22 wherein the camera is a visible light camera and the images are visible images.

31. The method of claim 30 wherein a visible light source within the enclosure and positioned to illuminate the panoramic view is pulsed each time the camera obtains a visible image for transmitting.

32. The method of claim 22 wherein at least one additional sensor is mounted within the enclosure and having its output coupled to the transmitter, and further comprising receiving the additional sensor signal transmitted by the transmitter.

33. The method of claim 32 wherein the additional sensor is a microphone.

34. The method of claim 32 wherein the additional sensor is a noxious gas sensor.

35. The method of claim 32 wherein the additional sensor is an explosive gas sensor.

36. The method of claim 22 further comprising an earth's magnetic field sensor within the enclosure and having an output coupled to the transmitter to transmit directional information, and further comprising receiving the directional information transmitted by the transmitter.

37. The method of claim 22 wherein the surveillance device is propelled into an area to be monitored by manually throwing the device.
